(19) United States
(12) Patent Application Publication
(10) Pub. No.: US 2023/0167996 A1
(43) Pub. Date: Jun. 1, 2023

(54) Control Of Room Comfort

(71) Applicant: Siemens Schweiz AG, Zürich (CH)

(72) Inventor: Henning Fuhrmann, Zürich (CH)

(73) Assignee: Siemens Schweiz AG, Zürich (CH)

(21) Appl. No.: 17/536,695

(22) Filed: Nov. 29, 2021

(51) Int. Cl. F24F 11/65; G05D 23/19; A62C 37/36; G05B 13/02

(52) U.S. Cl. CPC F24F 11/65; G05D 23/193; A62C 37/36; G05B 13/024; F24F 2140/50

(57) ABSTRACT

Various embodiments of the teachings herein include a method of controlling a comfort parameter with a system comprising a user interface device, a sensor, and a control device, wherein the sensor measures a parameter different from the comfort parameter. The method may include: providing a demand signal requesting a change in the comfort parameter from a user using the user interface device; transmitting the demand signal from the user interface device to the control device; obtaining a reading from the sensor, the reading corresponding to a value of the parameter; analyzing the demand signal based on a current state of the system the reading obtained from the sensor; changing one or more settings of the system based on the analysis of the demand signal; and producing a control signal as a function of the one or more changed settings of the system.

### TECHNICAL FIELD

The present disclosure relates to control and/or regulation of at least one room comfort parameter of a site. Various embodiments of the teachings herein include control and/or regulation of a room comfort parameter, wherein a measure of the parameter is obtained from a non-dedicated sensor.

### BACKGROUND

Control and/or regulation of at least one room comfort parameter is typically employed for purposes such as heating and/or ventilation and/or air-conditioning (HVAC) and/or cooling and/or lighting. Control and/or regulation of the at least one room comfort parameter can be implemented by a building automation system such as a HVAC system. Control and/or regulation of the at least one room comfort parameter can be applied to a building as a whole and/or to various zones of a building. The building can be a commercial and/or industrial and/or residential building. Room comfort parameters to be controlled or regulated are, by way of non-limiting example, temperature and/or humidity and/or air quality.

Nowadays, a HVAC system for a building is in operation all year round. The HVAC system may be partially or fully automated and control the comfort requirements of the occupants of the building. Control of comfort requirements typically accommodates economic and ecological aspects. To that end, control and/or regulation of a room comfort variable involves building parameters and/or system parameters and/or environmental constraints and/or set points and/or occupancy patterns. Occupancy patterns can be derived from programmable time switches and/or from occupancy schedules.

The programming stored in the automatic mode does not always match the current needs of the people in the building. A user can temporarily change the operating mode of the HVAC system and/or of a heating control. A user can also adjust a temporary or permanent set point. A user can as well apply a temporary correction of a set point.

In any case, the user must first understand the impact of such changes on the control parameters of the system. This requires an in-depth analysis by the user. With most HVAC systems, the user will have to analyse and understand the operating mode and/or the operating level as determined by a time switch program. The user will also have to analyse and understand a temperature set point of the system. Based on the in-depth analysis, the user should be able to evaluate what parameters need to change in order to arrive at a desired change in temperature.

Patent application EP0590250A1 describes a method for heat characteristics adjustment of a heating circuit controller. More specifically, EP0590250A1 describes a method for setting the heating curve of a heating circuit controller by applying a new room temperature set point. A user provides the new room temperature set point by means of a control element. That is, the user directly changes settings of the heating circuit controller.

European patent application EP2775369A1 deals with control and regulation of a room comfort value. Therein, a room comfort parameter is controlled based on a demand signal such as temperature up or temperature down. A user provides the demand signal. The demand signal does not indicate a set point value. Instead, the demand signal provided by the user indicates a desired change in the room comfort parameter. A user may, by way of example, indicate that a temperature inside a room shall increase or decrease. The system then statistically analyses the demand signals and derives a new set point.

Patent application EP2903217A1 deals with a building automation method and with a system. EP2903217A1 teaches that occupancy and behavioural patterns can be derived from meters and sensors, where the meters and sensors are part of standard infrastructure. The meters comprise electricity meters and water meters. The sensors can be temperature sensors, humidity sensors, carbon dioxide sensors, sensors for volatile organic compounds, and other sensors as used in ventilation control.

A sensor to be used in ventilation control is described in patent application EP3569995A1 describing a sensor recording temperature and pressure. The sensor of EP3569995A1 records pressure using a measurement diaphragm and records temperature using a meandering pattern layer. The diaphragm of the capacitive pressure transducer comprises meandering pattern layer. An electric current along the meandering pattern layer provides an indication of temperature at or near the diaphragm.
Patent application US2012/016526A1 describes a heating, ventilation, and air conditioning management system and method.
Patent application US2017/356669A1 describes a HVAC control system with user interface provided by a mobile wireless device.

### SUMMARY

The instant disclosure introduces control and/or regulation of a HVAC system, wherein a non-dedicated sensor is part of the control system. The primary purpose of the non-dedicated sensor is different from measuring room temperature. The present disclosure teaches control and/or regulation of at least one room comfort parameter of a site based on a non-dedicated sensor. The site can be a building such as a commercial and/or industrial and/or residential building. To that end, a user provides a request for the at least one room comfort parameter to change. More specifically, the user provides a direction of that change. An estimate of temperature that correlates with room temperature is obtained. A system such as a HVAC system of the site and/or a HVAC system of the building then changes the at least one room comfort parameter based on the request provided by the user and based on the estimate of temperature.

For example, some embodiments of the teachings herein include a method of controlling at least one comfort parameter in a building, the building comprising a system for controlling the at least one comfort parameter, the system for controlling the at least one comfort parameter comprising a user interface device (1), a sensor (4), and a control device (7, 10), wherein the primary purpose of the sensor (4) is different from recording a signal indicative of the at least one comfort parameter, the method comprising the steps of: providing a demand signal in respect of a change in the at least one comfort parameter, wherein the demand signal is provided by a user and using the user interface device (1); the user interface device (1) transmitting the demand signal to the control device (7, 10); the control device (7, 10) obtaining a reading from the sensor (4), the reading being indicative of a parameter other than the at least one comfort parameter; the control device (7, 10) analysing the demand signal based on a current state of the system for controlling the at least one comfort parameter and based on the reading obtained from the sensor (4); the control device (7, 10) changing one or more settings (8, 12) of the system for controlling the at least one comfort parameter based on the analysis of the demand signal; and the control device (7, 10) producing a control signal as a function of the one or more changed settings (8, 12) of the system.

In some embodiments, the building comprises a smoke detector (14) and wherein the sensor (4, 15) is a temperature sensor (15) inside the smoke detector (14), wherein the at least one comfort parameter is a room temperature of a room of the building, the method comprising the steps of: the control device (7, 10) obtaining a reading from the sensor (4, 15), the reading being a temperature reading indicative of a temperature inside the smoke detector (14); and the control device (7, 10) analysing the demand signal based on a current state of the system for controlling the room temperature of the room of the building and based on the temperature reading obtained from the sensor (4, 15).

In some embodiments, the method further includes: the smoke detector (14) determining an operating condition of the smoke detector (14) selected from a fire hazard or normal operation; the smoke detector (14) upon determining that the operating condition is normal operation transmitting a reading of the temperature sensor (15) to the control device (7, 10); the control device (7, 10) receiving the reading of the temperature sensor (15), the reading being a temperature reading indicative of a temperature inside the smoke detector (14); and the control device (7, 10) analysing the demand signal based on a current state of the system for controlling the room temperature of the room of the building and based on the temperature reading.

In some embodiments, the building comprises a computing device having a processor and wherein the sensor (4) is a temperature sensor of the processor of the computing device, wherein the at least one comfort parameter is a room temperature of a room of the building, the method comprising the steps of: the control device (7, 10) obtaining a temperature reading from the sensor (4), the temperature reading being indicative of a temperature of the processor; and the control device (7, 10) analysing the demand signal based on a current state of the system for controlling the room temperature of the room of the building and based on the temperature reading.

In some embodiments, the method further comprises: the control device (7, 10) additionally obtaining a load reading from the processor of the computing device, the load reading being indicative of a current load of the processor; the control device (7, 10) producing an estimate of temperature based on the load reading and based on the temperature reading; and the control device (7, 10) analysing the demand signal based on a current state of the system for controlling the room temperature of the room of the building and based on the estimate of temperature.

In some embodiments, the building comprises a computing device having a processor and wherein the sensor (4) is a temperature sensor of the processor of the computing device, wherein the at least one comfort parameter is a room temperature of a room of the building, the method comprising the steps of: the control device (7, 10) obtaining from the processor a plurality of measurement data sets, each of the measurement data sets including for a different point in time a temperature reading obtained from the sensor (4) and a load reading of and determined by the processor; the control device (7, 10) producing an estimate of temperature from the plurality of measurement data sets; and the control device (7, 10) analysing the demand signal based on a current state of the system for controlling the room temperature of the room of the building and based on the estimate of temperature.

In some embodiments, the method further comprises the control device (7, 10) performing a regression analysis to calculate the estimate of temperature from the plurality of measurement data sets.

In some embodiments, the building comprises a computing device having a processor and wherein the sensor (4) is a temperature sensor of the processor of the computing device, wherein the at least one comfort parameter is a room temperature of a room of the building, the method comprising the steps of: the processor obtaining a temperature reading from the sensor (4), the temperature reading being indicative of a temperature of the processor; the processor determining a load value, the load value being indicative of a current load of the processor; the processor producing an estimate of temperature based on the load value and based on the temperature reading; the processor transmitting the estimate of temperature to the control device (7, 10); and the control device (7, 10) analysing the demand signal based on a current state of the system for controlling the room temperature of the room of the building and based on the estimate of temperature.

In some embodiments, the building comprises a computing device having a processor and wherein the sensor (4) is a temperature sensor of the processor of the computing device, wherein the at least one comfort parameter is a room temperature of a room of the building, the method comprising the steps of: the processor collecting a plurality of measurement data sets, each of the measurement data sets including for a different point in time a temperature reading obtained from the sensor (4) and a load reading of and determined by the processor; the processor producing an estimate of temperature from the plurality of measurement data sets; the processor transmitting the estimate of temperature to the control device (7, 10); and the control device (7, 10) analysing the demand signal based on a current state of the system for controlling the room temperature of the room of the building and based on the estimate of temperature.

In some embodiments, the method further comprises the processor performing a regression analysis to calculate the estimate of temperature from the plurality of measurement data sets.

In some embodiments, the building comprises a sensor assembly (32, 33) having an auxiliary temperature sensor for compensating temperature drift of the sensor assembly (32, 33), a room (27), and a duct (29, 31) selected from an inlet duct for flow of air from outside the building to the room (27) or an outlet duct for flow of air from the room (27) out of the building, wherein the sensor assembly (32, 33) is secured relative to the duct (29, 31), wherein the at least one comfort parameter is a room temperature of the room (27) of the building, wherein the sensor (4) is the auxiliary temperature sensor of the sensor assembly (32, 33), the method comprising the steps of: the control device (7, 10) obtaining a reading from the sensor (4), the reading being a temperature reading indicative of a temperature inside the duct (29, 31); and the control device (7, 10) analysing the demand signal based on a current state of the system for controlling the room temperature of the room (27) of the building and based on the temperature reading obtained from the sensor (4).

In some embodiments, the building comprises a first sensor assembly (32) having a first auxiliary temperature sensor for compensating temperature drift of the first sensor assembly (32) and a second sensor assembly (33) having a second auxiliary temperature sensor for compensating temperature drift of the second sensor assembly (33), a room (27), and an inlet duct (29) for flow of air from outside the building to the room (27) and an outlet duct (31) for flow of air from the room (27) out of the building, wherein the first sensor assembly (32) is secured relative to the inlet duct (29) and the second sensor assembly (33) is secured relative to the outlet duct (31), wherein the at least one comfort parameter is a room temperature of the room (27) of the building, the method comprising the steps of: the control device (7, 10) obtaining a first reading from the first auxiliary temperature sensor of the first sensor assembly (32), the first reading being a temperature reading indicative of a temperature inside the inlet duct (29); the control device (7, 10) obtaining a second reading from the second auxiliary temperature sensor of the second sensor assembly (33), the second reading being a temperature reading indicative of a temperature inside the outlet duct (31); and the control device (7, 10) analysing the demand signal based on a current state of the system for controlling the room temperature of the room (27) of the building and based on the first reading and based on the second reading.

In some embodiments, the method further comprises: the control device (7, 10) producing a first measure of temperature from the first reading; the control device (7, 10) producing a second measure of temperature from the second reading; the control device (7, 10) producing an estimate of temperature by averaging the first and second measures of temperature; and the control device (7, 10) analysing the demand signal based on a current state of the system for controlling the room temperature of the room (27) of the building and based on the estimate of temperature.

As another example, some embodiments include a computer program comprising instructions which, when the program is executed by a computer, cause the computer to carry out a method incorporating teachings of the present disclosure.

As another example, some embodiments include a computer-readable medium comprising instructions which, when executed by a computer, cause the computer to carry out a method incorporating teachings of the present disclosure.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic drawing of a HVAC system using a non-dedicated sensor incorporating teachings of the present disclosure;

FIG. 2 is a schematic drawing of a non-dedicated sensor embodied as a temperature sensor of a smoke detector incorporating teachings of the present disclosure;

FIG. 3 shows a plot of processor temperature versus processor load incorporating teachings of the present disclosure;

FIG. 4 schematically shows a sensor primarily for sensing pressure incorporating teachings of the present disclosure;

FIG. 5 shows a meandering path for a sensor incorporating teachings of the present disclosure; and

FIG. 6 shows inlet conduits and outlet conduits of a site, the conduits being equipped with non-dedicated sensors incorporating teachings of the present disclosure.

### DETAILED DESCRIPTION

The present disclosure teaches various methods and systems for control and/or regulation, where a dedicated room sensor such as a temperature sensor inside a thermostat is not available. The teachings herein leverage non-dedicated sensors such as temperature sensors inside smoke detectors and/or temperature sensors of processors of computing devices and/or temperature sensors for drift compensation of pressure sensors. These non-dedicated sensors have in common that their primary purpose is different from recording room temperature. The primary purpose of a temperature sensor inside a smoke detector is to detect a fire. The primary purpose of a temperature sensor of a processor is to limit load. The primary sensor of a pressure sensor is to measure pressure. The pressure sensor can nonetheless employ a temperature sensor to afford compensation of temperature drift.

Commercial and/or industrial buildings frequently have smoke detectors installed at or near the ceilings of those buildings. The smoke detectors often record temperature albeit at or near a ceiling of a space. Even though smoke detectors installed at or near ceilings do not record room temperatures, their signals offer indications of room temperature. The teachings herein leverage such signals and leverages one or more requests provided by a user to control and/or to regulate room temperature.

Processors of desktop computers and processors of laptop computers provide temperature sensors. Likewise, processors of single-board computers provide such temperature sensors. The primary purpose of temperature sensors of processors is load management. These sensors can nonetheless provide indications of room temperature, especially when the processors are idle. What is more, these sensors can provide indications of room temperature by linking measured temperature and measured load to an estimate of room temperature. The teachings herein leverage temperature signals originating from processors and leverages one or more requests provided by a user to control and/or to regulate room temperature.

Pressure sensors can be installed in the ducts of a HVAC system. Pressure sensors can, by way of non-limiting example, be installed in the inlet ducts and/or in the outlet ducts of such systems. These pressure sensors often require a temperature sensor at or near the pressure sensor element to compensate temperature drift of the pressure sensor element. Even though temperatures recorded in inlet ducts and in outlet ducts differ from room temperatures, temperatures originating from those sensors can be used to estimate room temperature. A duct can, by way of non-limiting example, end in a room. A sensor can be installed near that end. A signal originating from an inlet duct can, by way of another non-limiting example, be combined with a signal originating from an outlet duct. The combined signal provides an estimate of room temperature. The combined signal is then used in conjunction with a request signal to control and/or to regulate room temperature.

Pressure sensors such as the sensor of EP3569995A1 can also provide indications of moisture in the vicinity of the sensor. If moisture electrically connects sensor elements that are otherwise insulated from one another, the same can short-circuit terminals of the sensor. A short-circuit condition between the terminals of the sensor will thus indicate moisture in the vicinity of the sensor. The teachings herein leverage such signals indicative of moisture to control and/or to regulate humidity in a room. More specifically, the teachings herein leverage signals indicative of moisture in conjunction with one or more requests provided by a user.

The quality of control and/or regulation based on non-dedicated sensors hinges on the accuracy of temperature estimates obtained from the sensors. Non-dedicated sensors such as the sensors mentioned above often provide coarse estimates of room temperatures. To enable accurate estimates of room temperatures, signals from non-dedicated sensors can be statistically analysed. Two signals originating from different non-dedicated sensors can, by way of non-limiting example, be averaged. A statistical distribution of signals originating from a single non-dedicated sensor can, by way of another non-limiting example, be determined. Based on the statistical distribution of those signals, outlier signals can be determined and can be suppressed.

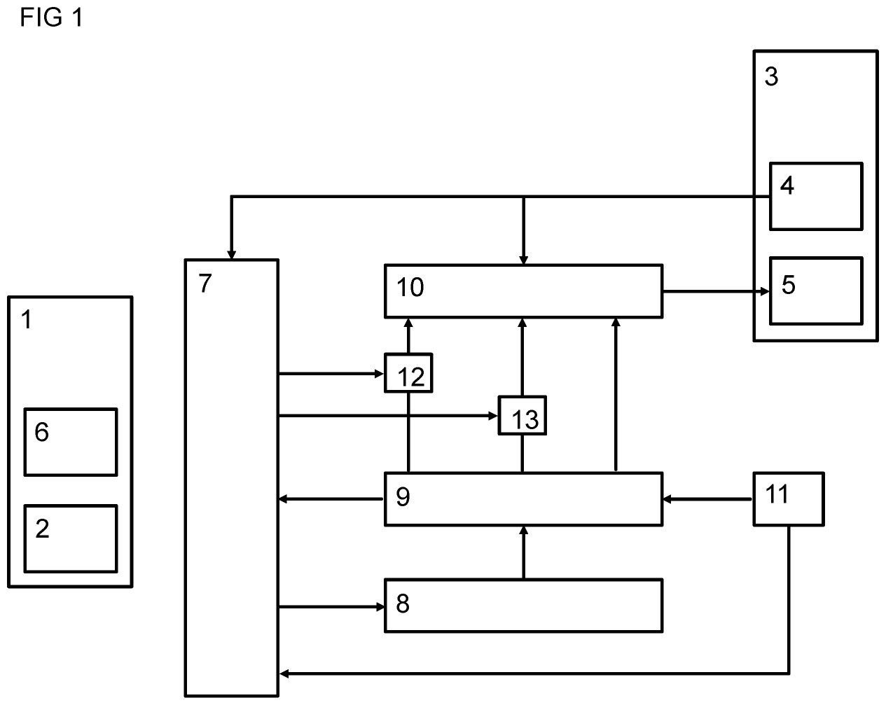

The teachings herein can be used to control and/or to regulate any room comfort parameter such as temperature or humidity. The mode of operation is exemplified, but not limited to, as the control or regulation of the room comfort parameter temperature. FIG. 1 schematically illustrates a HVAC system wherein a user can specify a direction of change of a room comfort parameter. As shown in FIG. 1, a request signal is entered.

The request signal applies to a change in a room comfort parameter such as room temperature. A user enters the request signal using a user interface device 1. The control device can, by way of non-limiting example, be a room device and/or a thermostat and/or a smart thermostat and/or a mobile computing device. The device 1 comprises an input device 2. In some embodiments, the input device 2 comprises a rocker switch. A position of the rocker switch indicates a change in temperature. Actuation of the rocker switch consequently causes an increase or a decrease in temperature in the room 3.

In some embodiments, the user interface device 1 may be configured for inputting a two-valued request signal such as temperature up or temperature down. Likewise, the user interface device 1 can be configured for inputting a two-valued request signal such as increase temperature or reduce temperature. The input device 2 can also comprise at least one of: buttons, switches, a touch screen such as a capacitive touch screen, a potentiometer, a graphical user interface of an application running on a mobile device, a voice recognition and speech processing system.

Room 3 provides a non-dedicated sensor 4. The main purpose of the non-dedicated sensor 4 is different from recording room temperature. The non-dedicated sensor is typically not mounted or arranged in a position that affords detection or measurements of room temperature. In an embodiment, the non-dedicated sensor 4 is a general-purpose sensor. In an embodiment, the non-dedicated sensor 4 is an indirect sensor. It is envisaged that the non-dedicated sensor 4 comprises at least one of: a smoke detector having a temperature sensor, a processor of a computing device, the processor having a temperature sensor, a pressure sensor having a temperature sensor to compensate for temperature drift of its pressure readings.

The room 3 can also provide one or more actuators 5. The one or more actuators 5 enable heating and/or cooling of the room 3. In some embodiments, the device 1 comprises an output device 6 for showing a user a (feedback) message. In some embodiments, the message provides feedback on an activation or on a deactivation of a heating/cooling module 7.

In some embodiments, the heating/cooling module 7 is operable to log and to statistically analyse signals received from the non-dedicated sensor 4. In some embodiments, the heating/cooling module 7 is operable to analyse frequencies of signals received from the non-dedicated sensor 4. In some embodiments, the heating/cooling module 7 receives signals from a plurality of non-dedicated sensors 4 and analyses these signals. In so doing, the heating/cooling module 7 can statistically analyse signals originating from a plurality of non-dedicated sensors 4. A statistical analysis of signals originating from a plurality of non-dedicated sensors 4 can, by way of non-limiting example, involve averaging these signals.

In some embodiments, the heating/cooling module 7 receives signals indicative of time from a clock 11. The heating/cooling module 7 is then operable to factor in time stamps of signals received from the non-dedicated sensor 4. The heating/cooling module 7 is also operable to statistically analyse time stamps of such signals. In some embodiments, the heating/cooling module 7 is operable to factor in time stamps of signals received from a plurality of non-dedicated sensors 4. In so doing, the heating/cooling module 7 can analyse time stamps of signals received from a plurality of non-dedicated sensors 4. The analysis of the time stamps of the signals received from a plurality of non-dedicated sensors 4 can involve a statistical analysis of the time stamps. The analysis of the time stamps of the signals received from a plurality of non-dedicated sensors 4 can involve clustering the time stamps.

A connection between the heating/cooling module 7 and the non-dedicated sensor 4 can be bidirectional. A bidirectional connection affords flexibility. The connection between the heating/cooling module 7 and the non-dedicated sensor 4 can also be unidirectional. Communication from the non-dedicated sensor 4 to the heating/cooling module 7 is afforded by such a unidirectional connection. A unidirectional connection reduces complexity.

In some embodiments, the connection between the heating/cooling module 7 and a plurality of non-dedicated sensors 4 can be bidirectional. A bidirectional connection affords flexibility. The connection between the heating/cooling module 7 and the plurality of non-dedicated sensors 4 can also be unidirectional. Communication from any non-dedicated sensor 4 of the plurality of non-dedicated sensors 4 to the heating/cooling module 7 is afforded by such a unidirectional connection. A unidirectional connection reduces complexity.

In some embodiments, the control and/or regulation of a HVAC system involves basic settings 8 that are permanent. Control and/or regulation of a HVAC system also involves basic settings 8 that rarely change. These basic settings depend on requirements and conditions for the respective building or site. The basic settings 8 can also depend on occupant's needs. The basic settings 8 are usually entered when the HVAC system is commissioned. The basic settings 8 can, by way of non-limiting example, comprise at least one of a schedule that depends on occupancy, set points for various modes such as comfort mode, pre-comfort mode, economy mode, protection mode, heating mode, cooling mode, control parameters such as proportional and integral parameters or proportional and integral and derivative parameters. The basic settings 8 may be stored in a basic settings module. The basic settings module preferably comprises a memory such as a non-volatile memory.

The basic settings 8 determine the operation and the mode of operation of the operations module 9. The operations module 9 determines operation of a control and/or regulation module 10. The operations module 9 can, by way of non-limiting example, comprise: a settings module. The settings module determines set points depending on a time signal obtained from the clock 11; an economy module. The economy module automatically applies an economy mode to the HVAC system. To that end, the economy module can turn off cooling and/or heating depending on seasons; and a relationship module storing basic relationships of the HVAC system such as heating curves and/or cooling curves. The operations module 9 may comprise a microcontroller and/or a microprocessor. In some embodiments, the operations module 9 comprises a memory such as a non-volatile memory.

The heating/cooling module 7 analyses the current status of the operations module 9. Upon completion of the analysis, the heating/cooling module 7 applies a temporary change 12 to data transmitted to the control and/or regulation module 10. Later, any values transmitted from the operations module 9 to the control and/or regulation module 10 will, again, be applied directly and without change. That is, any change applied by the heating/cooling module 7 is temporary.

A temporary change 12 of the data transmitted to the control and/or regulation module 10 is preferably applied until an event is registered. An event can, by way of non-limiting example, be another request signal received from the user interface device 1. An event can, by way of another non-limiting example, be the expiry of a predetermined time span. To that end, the heating/cooling module 7 can comprise a watchdog timer.

In some embodiments, the HVAC system comprises an override switch 13. The override switch 13 receives an override signal from the heating/cooling module 7. The override switch 13 upon receipt of the override signal switches the current state of the control and/or regulation module 10 to a temporary state. The override switch 13 thus causes a temporary change of data transmitted from the operations module 9 to the control/regulation module 10. The override switch 13 can also cause a temporary replacement of data transmitted from the operations module 9 to the control/regulation module 10. In some embodiments, the override switch 13 can also cause a temporary stop of data transmission from the operations module 9 to the control/regulation module 10.

The heating/cooling module 7 thus inhibits unintentional and/or incorrect manipulations of the basic settings 8. In some embodiments, the heating/cooling module 7 is operable to log and to statistically analyse requests received from the user interface device 1. It is envisaged that the heating/cooling module 7 is operable to analyse frequencies of requests received from the user interface device 1.

In some embodiments, the heating/cooling module 7 receives signals indicative of time from the clock 11. The heating/cooling module 7 is then operable to factor in time stamps of requests received from the user interface device 1. The heating/cooling module 7 is also operable to statistically analyse inputs and time stamps of such requests.

In some embodiments, the heating/cooling module 7 is operable to make permanent changes to the basic settings 8. The heating/cooling module 7 can, by way of non-limiting example, statistically analyse requests and permanently change basic settings 8 based on the analysis of such a request. The heating/cooling module 7 can, by way of non-limiting example, determine the frequency of request signals and permanently change basic settings 8 based on the determined frequency. The heating/cooling module 7 can, by way of non-limiting example, determine the time stamps of request signals. The heating/cooling module 7 then and permanently changes basic settings 8 based on the time stamps.

To accomplish such changes, the heating/cooling module 7 may have write access to a memory of the basic settings module. The heating/cooling module 7 advantageously has write access to a non-volatile memory of the basic settings module. In some embodiments, the heating/cooling module 7 comprises a microcontroller and/or a microprocessor.

In some embodiments, the heating/cooling module 7 and the operations module 9 are arranged on the same system-on-a-chip. In some embodiments, the heating/cooling module 7 and the operations module 9 comprise the same microcontroller. In some embodiments, the heating/cooling module 7 and the operations module 9 comprise the same microprocessor.

In some embodiments, the control/regulation module 10 is operable to log and to statistically analyse signals received from the non-dedicated sensor 4. In some embodiments, the control/regulation module 10 is operable to analyse frequencies of signals received from the non-dedicated sensor 4. In some embodiments, the control/regulation module 10 receives signals from a plurality of non-dedicated sensors 4 and analyses these signals. In so doing, the control/regulation module 10 can statistically analyse signals originating from a plurality of non-dedicated sensors 4. A statistical analysis of signals originating from a plurality of non-dedicated sensors 4 can, by way of non-limiting example, involve averaging these signals.

A connection between the control/regulation module 10 and the non-dedicated sensor 4 can be bidirectional. A bidirectional connection affords flexibility. The connection between the control/regulation module 10 and the non-dedicated sensor 4 can also be unidirectional. Communication from the non-dedicated sensor 4 to the control/regulation module 10 is afforded by such a unidirectional connection. A unidirectional connection reduces complexity.

A connection between the control/regulation module 10 and a plurality of non-dedicated sensors 4 can be bidirectional. A bidirectional connection affords flexibility. The connection between the control/regulation module 10 and the plurality of non-dedicated sensors 4 can also be unidirectional. Communication from any non-dedicated sensor 4 of the plurality of non-dedicated sensors 4 to the control/regulation module 10 is afforded by such a unidirectional connection. A unidirectional connection reduces complexity.

In some embodiments, the heating/cooling module 7 and the control/regulation module 10 are arranged on the same system-on-a-chip. In some embodiments, the heating/cooling module 7 and the control/regulation module 10 comprise the same microcontroller. In some embodiments, the heating/cooling module 7 and the control/regulation module 10 comprise the same microprocessor.

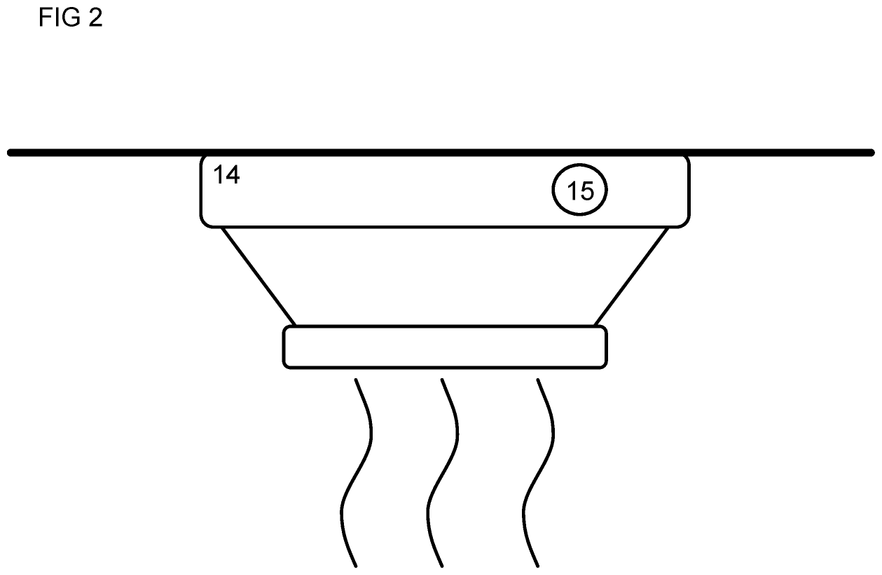

In some embodiments, the non-dedicated sensor 4 can comprise a temperature sensor 15 of a smoke detector 14. The non-dedicated sensor 4 can also be a temperature sensor 15 of a smoke detector 14. FIG. 2 shows a smoke detector 14 having a temperature sensor 15. The smoke detector 14 as shown in FIG. 2 is typically mounted to a ceiling of a space. The smoke detector 14 as shown in FIG. 2 can be mounted to a ceiling of a room of a building. The smoke detector 14 as shown in FIG. 2 can also be mounted to a ceiling of a zone of a building.

Any communication between the smoke detector 14 and the heating/cooling module 7 may involve a digital communication bus. In some embodiments, communication between the smoke detector 14 and the heating/cooling module 7 may involve a digital communication protocol. Likewise, communication between the temperature sensor 15 and the heating/cooling module 7 preferably involves a digital communication bus. In some embodiments, communication between the temperature sensor 15 and the heating/cooling module 7 involves a digital communication protocol.

Communication between the smoke detector 14 and the heating/cooling module 7 can, by way of non-limiting example, rely on wireless solutions such as WLAN, KNX® RF, Thread, Zigbee, and/or Enocean®. Likewise, communication between the temperature sensor 15 and the heating/cooling module 7 can, by way of non-limiting example, rely on wireless solutions such as WLAN, KNX® RF, Thread, Zigbee, and/or Enocean®. Communication between the smoke detector 14 and the heating/cooling module 7 can, by way of another non-limiting example, rely on hard-wired connections such as Ethernet® cables or on KNX® cables. Likewise, communication between the temperature sensor 15 and the heating/cooling module 7 can, by way of another non-limiting example, rely on hard-wired connections such as Ethernet® cables or on KNX® cables.

In some embodiments, communication between the smoke detector 14 and the heating/cooling module 7 involves a digital, proprietary communication bus. That is, the smoke detector 14 transmits a signal to a server of a smoke detection system using the digital, proprietary communication bus. The server of the smoke detection system then forwards the signal to the heating/cooling module 7 using an additional bus. The additional bus is different from the digital, proprietary communication bus. The additional bus, can, by way of non-limiting example, involve BACnet® communication.

In some embodiments, any communication between the smoke detector 14 and the control/regulation module 10 involves a digital communication bus. Communication between the smoke detector 14 and the control/regulation module 10 involves a digital communication protocol. Likewise, communication between the temperature sensor 15 and the control/regulation module 10 may involve a digital communication bus. Communication between the temperature sensor 15 and the control/regulation module 10 may involve a digital communication protocol. Communication between the smoke detector 14 and the control/regulation module 10 can, by way of non-limiting example, rely on wireless solutions such as WLAN, KNX® RF, Thread, Zigbee, and/or Enocean®. Likewise, communication between the temperature sensor 15 and the control/regulation module 10 can, by way of non-limiting example, rely on wireless solutions such as WLAN, KNX® RF, Thread, Zigbee, and/or Enocean®.

Communication between the smoke detector 14 and the control/regulation module 10 can, by way of another non-limiting example, rely on hard-wired connections such as Ethernet® cables or on KNX® cables. Likewise, communication between the temperature sensor 15 and the control/regulation module 10 can, by way of another non-limiting example, rely on hard-wired connections such as Ethernet® cables or on KNX® cables.

In some embodiments, communication between the smoke detector 14 and the control/regulation module 10 involves a digital, proprietary communication bus. That is, the smoke detector 14 transmits a signal to a server of a smoke detection system using the digital, proprietary communication bus. The server of the smoke detection system then forwards the signal to the control/regulation module 10 using an additional bus. The additional bus is different from the digital, proprietary communication bus. The additional bus, can, by way of non-limiting example, involve BACnet® communication.

The non-dedicated sensor 4 can comprise a temperature sensor of a processor of a computing device. The non-dedicated sensor 4 can also be a temperature sensor of a processor of a computing device. The computing device may be selected from at least one of: a desktop computer and/or a portable computer such as a laptop computer and/or a single-board computer.

In some embodiments, any communication between the computing device and the heating/cooling module 7 involves a digital communication bus. Communication between the computing device and the heating/cooling module 7 advantageously involves a digital communication protocol. In some embodiments, communication between the processor of the computing device and the heating/cooling module 7 involves a digital communication bus. Communication between the processor of the computing device and the heating/cooling module 7 involves a digital communication protocol. Communication between the computing device and the heating/cooling module 7 can, by way of non-limiting example, rely on wireless solutions such as WLAN, KNX® RF, Thread, Zigbee, and/or Enocean®. Likewise, communication between the processor of the computing device and the heating/cooling module 7 can, by way of non-limiting example, rely on wireless solutions such as WLAN, KNX® RF, Thread, Zigbee, and/or Enocean®. Communication between the computing device and the heating/cooling module 7 can, by way of another non-limiting example, rely on hard-wired connections such as Ethernet® cables or on KNX® cables. Likewise, communication the processor of the computing device and the heating/cooling module 7 can, by way of another non-limiting example, rely on hard-wired connections such as Ethernet® cables or on KNX® cables.

In some embodiments, any communication between the computing device and the control/regulation module 10 involves a digital communication bus. Communication between the computing device and the control/regulation module 10 involves a digital communication protocol. In some embodiments, communication between the processor of the computing device and the control/regulation module 10 involves a digital communication bus. Communication between the processor of the computing device and the control/regulation module 10 involves a digital communication protocol. Communication between the computing device and the control/regulation module 10 can, by way of non-limiting example, rely on wireless solutions such as WLAN, KNX® RF, Thread, Zigbee, and/or Enocean®. Likewise, communication between the processor of the computing device and the control/regulation module 10 can, by way of non-limiting example, rely on wireless solutions such as WLAN, KNX® RF, Thread, Zigbee, and/or Enocean®. Communication between the computing device and the control/regulation module 10 can, by way of another non-limiting example, rely on hard-wired connections such as Ethernet® cables or on KNX® cables. Likewise, communication between the processor of the computing device and the control/regulation module 10 can, by way of another non-limiting example, rely on hard-wired connections such as Ethernet® cables or on KNX® cables.

A room temperature can be estimated from the signal obtained from the computing device by factoring in the load of the computing device. A room temperature can, by way of non-limiting example, be estimated based on a temperature of the processor and based on the load of the processor. In some embodiments, the heating/cooling module 7 estimates a room temperature based on a temperature of the processor and based on the load of the processor. In some embodiments, the control/regulation module 10 estimates a room temperature based on a temperature of the processor and based on the load of the processor. In some embodiments, the processor estimates room temperature based on its own temperature and based on its own load. The processor then transmits the estimate to the heating/cooling module 7 and/or to the control/regulation module 10.

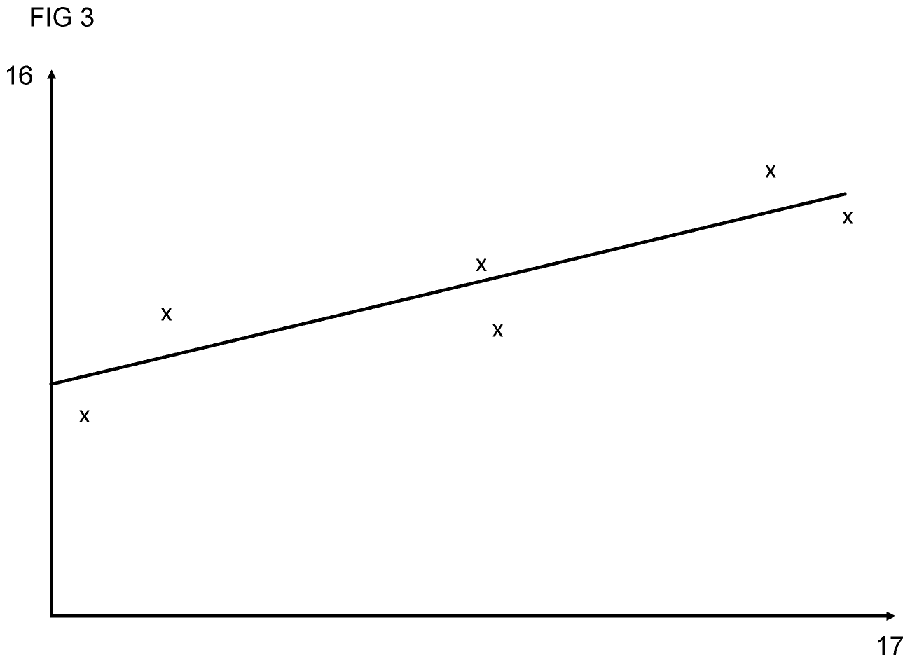

FIG. 3 shows a plot of temperature 16 of the processor versus load 17 of the processor. The heating/cooling module 7 can obtain a first series of load values and a second series of temperature values. The heating/cooling module 7 then estimates room temperature based on the first series and based on the second series. In some embodiments, the heating/cooling module 7 applies a regression analysis to estimate room temperature based on the first series and based on the second series. In a special embodiment, the heating/cooling module 7 applies linear regression to estimate room temperature based on the first series and based on the second series. Ideally, every load value of the first series is associated with a temperature value of the second series.

In some embodiments, the control/regulation module 10 obtains a first series of load values and a second series of temperature values. The control/regulation module 10 then estimates room temperature based on the first series and based on the second series. In an embodiment, the control/regulation module 10 applies a regression analysis to estimate room temperature based on the first series and based on the second series. In a special embodiment, the control/regulation module 10 applies linear regression to estimate room temperature based on the first series and based on the second series. In some embodiments, every load value of the first series is associated with a temperature value of the second series.

In some embodiments, the processor of the computing device obtains a first series of load values and a second series of temperature values. The processor of the computing device then estimates room temperature based on the first series and based on the second series. In some embodiments, the processor of the computing device applies a regression analysis to estimate room temperature based on the first series and based on the second series. In some embodiments, the processor applies linear regression to estimate room temperature based on the first series and based on the second series. The processor eventually transmits the estimate to the heating/cooling module 7 and/or to the control/regulation module 10. In some embodiments, every load value of the first series is associated with a temperature value of the second series.

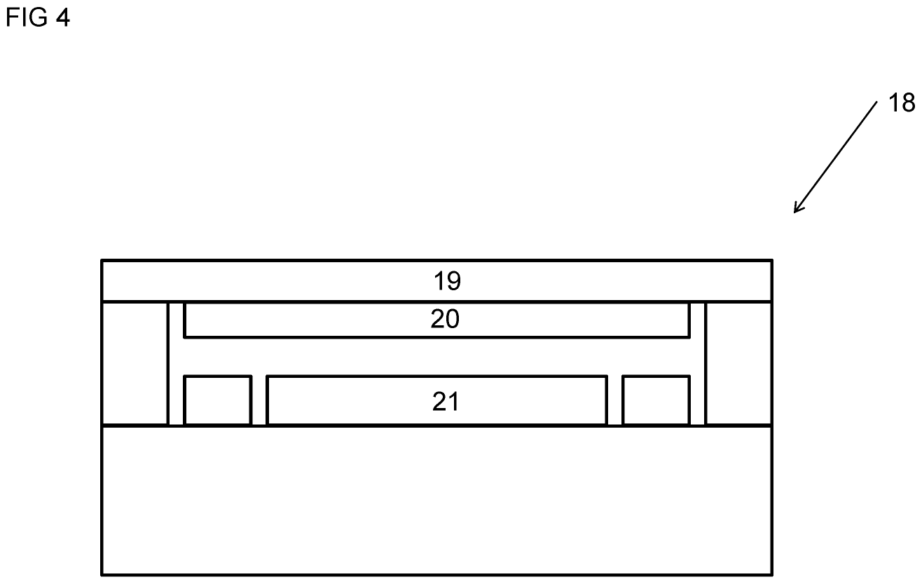

Now turning to FIG. 4, a sensor 18 having a diaphragm 19 and a pair of measurement electrodes 20, 21 is shown. A pressure applied to the diaphragm 19 will impact on the capacitor formed by the measurement electrodes 20, 21. Consequently, the capacitance of the capacitor formed by the measurement electrodes 20, 21 will change. A change in pressure thus results in a change in capacitance. The change in capacitance can be detected electrically. The change in capacitance can be used as an indication of a change in pressure.

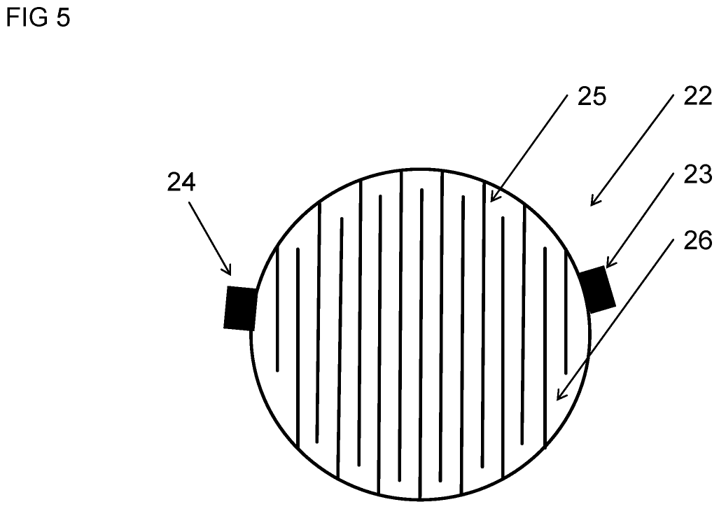

Since the measured capacitance also depends on temperature, the sensor 18 of FIG. 4 will require adequate compensation of temperature drift. To that end, a meandering pattern 22 as shown in FIG. 5 can be applied to any one of the measurement electrodes 20, 21. The meandering pattern 22 produces a meandering path for an electric current between the terminals 23 and 24. A change in resistivity of the meandering path can be an indication of a change in temperature. A measurement of pressure via the sensor 18 can account for that change in temperature thereby producing more accurate measurements of pressure.

A short-circuit can form between segments 25, 26 of the meandering pattern 22 due to moisture and/or humidity. That resistivity of the meandering path then changes due to the short-circuit. Accordingly, a change in resistivity of the meandering path can serve as an indication of moisture. Likewise, a change in resistivity of the meandering path can serve as an indication of humidity.

In some embodiments, the non-dedicated sensor 4 comprises a sensor 18 as shown on FIG. 4. The primary purpose of the sensor 18 is not temperature measurement. The primary purpose of the sensor 18 is not humidity measurement or moisture measurement, either. The primary purpose of the sensor 18 is measurement of pressure. To that end, the sensor 18 can be installed in an inlet duct of a HVAC system of a building. The sensor 18 can also be installed in an outlet duct of the HVAC system of the building.

The sensor 18 produces byproduct signals indicative of temperature and/or humidity and/or moisture in the duct. The heating/cooling unit 7 receives such signals and leverages them to control and/or to regulate temperature. More specifically, the heating/cooling unit 7 leverages the signals to control and/or to regulate temperature in a space such as a room of the building. It is also envisaged that the heating/cooling unit 7 leverages the signals to control and/or to regulate humidity in a space such as a room of the building. It is still envisaged that the heating/cooling unit 7 leverages the signals to control and/or to regulate moisture in a space such as a room of the building.

Likewise, the control/regulation unit 10 receives signals indicative of temperature and/or humidity and/or moisture in the duct from the sensor 18. The control/regulation unit 10 receives such signals and leverages them to control and/or to regulate temperature. In some embodiments, the control/regulation unit 10 leverages the signals to control and/or to regulate temperature in a space such as a room of the building. In some embodiments, the control/regulation unit 10 leverages the signals to control and/or to regulate humidity in a space such as a room of the building. In some embodiments, the control/regulation unit 10 leverages the signals to control and/or to regulate moisture in a space such as a room of the building.

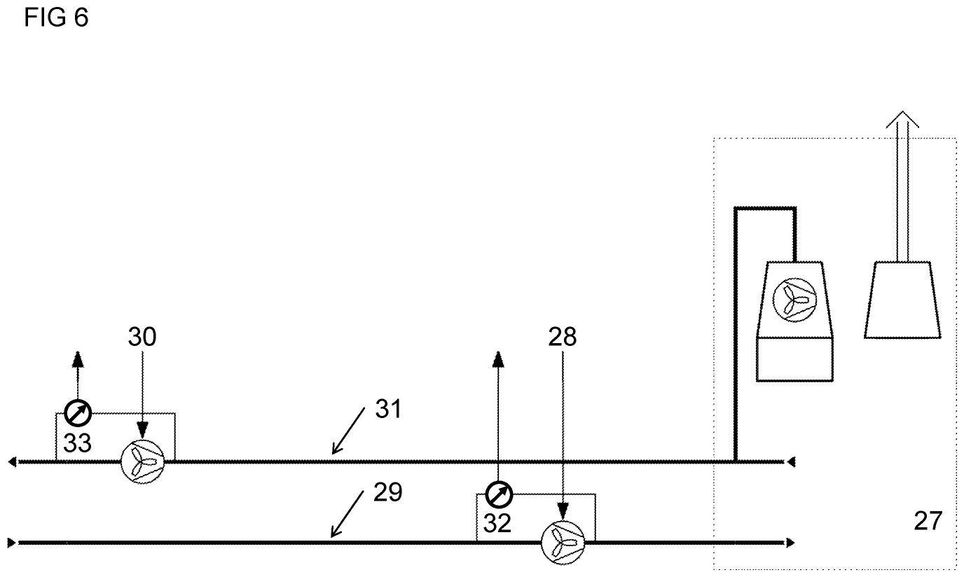

Now referring to FIG. 6, a space 27 of a building is illustrated. The space 27 can, by way of non-limiting example, be a room of a building. A fan 28 in an inlet duct 29 conveys air toward the space 27. A fan 30 in an outlet duct 31 conveys air away from the space 27.

A first non-dedicated sensor 32 records a pressure drop at or across the fan 28 in the inlet duct 29. In some embodiments, the first non-dedicated sensor 32 comprises a sensor as illustrated in FIG. 4 and in FIG. 5. A second non-dedicated sensor 33 records a pressure drop at or across the fan 30 in the outlet duct 31. In some embodiments, the second non-dedicated sensor 32 comprises a sensor as illustrated in FIG. 4 and in FIG. 5.

In an embodiment, the non-dedicated sensors 32, 33 are in operative communication with the heating/cooling module 7. The heating/cooling module 7 is operable to collect and to statistically analyse signals received from the non-dedicated sensors 32, 33. A statistical analysis of signals originating from a plurality of non-dedicated sensors 32, 33 can, by way of non-limiting example, involve averaging these signals.

In some embodiments, the non-dedicated sensors 32, 33 are in operative communication with the control/regulation module 10. The control/regulation module 10 is operable to collect and to statistically analyse signals received from the non-dedicated sensors 32, 33. A statistical analysis of signals originating from a plurality of non-dedicated sensors 32, 33 can, by way of non-limiting example, involve averaging these signals.

Any steps of methods described in the present disclosure can be embodied in hardware and/or in a software module executed by a processor and/or in a software module executed by a processor inside a container using operating system level virtualisation and/or in a cloud computing arrangement, or in a combination thereof. The software may include a firmware and/or a hardware driver run by the operating system and/or or an application program. Thus, the disclosure also relates to a computer program product for performing the operations presented herein. If implemented in software, the functions described may be stored as one or more instructions on a computer-readable medium. Some examples of storage media that can be used include random access memory (RAM) and/or read only memory (ROM) and/or flash memory and/or EPROM memory and/or EEPROM memory and/or registers and/or a hard disk and/or a removable disk and/or other optical disks and/or or any available media that can be accessed by a computer or any other IT equipment and appliance.

As described in detail herein, the present disclosure teaches a method of controlling at least one comfort parameter in a building, the building comprising a system for controlling the at least one comfort parameter, the system for controlling the at least one comfort parameter comprising a user interface device (1), a sensor (4), and a control device (7, 10), wherein the primary purpose of the sensor (4) is different from recording a signal indicative of the at least one comfort parameter, the method comprising the steps of: providing a demand signal in respect of a change in the at least one comfort parameter, wherein the demand signal is provided by a user and using the user interface device (1); the user interface device (1) transmitting the demand signal to the control device (7, 10); the control device (7, 10) obtaining a reading from the sensor (4), the reading being indicative of a parameter other than the at least one comfort parameter; the control device (7, 10) analysing the demand signal based on a current state of the system for controlling the at least one comfort parameter and based on the reading obtained from the sensor (4); the control device (7, 10) changing one or more settings (8, 12) of the system for controlling the at least one comfort parameter based on the analysis of the demand signal; and the control device (7, 10) producing a control signal as a function of the one or more changed settings (8, 12) of the system.

In some embodiments, the method of controlling at least one comfort parameter in a building is a method of controlling at least one comfort parameter of a building. In some embodiments, the method of controlling at least one comfort parameter in a building is a method of controlling at least one comfort parameter in a room, the room comprising a system for controlling the at least one comfort parameter. In some embodiments, the method of controlling at least one comfort parameter in a building is a method of controlling at least one comfort parameter of a room, the room comprising a system for controlling the at least one comfort parameter.

In some embodiments, the user interface device (1) is different from the control device (7, 10). In some embodiments, the user interface device (1) is different from the sensor (4). In some embodiments, the control device (7, 10) is different from the sensor (4). The user interface device (1) is in operative communication with the control device (7, 10). The sensor (4) preferably is in operative communication with the control device (7, 10).

In some embodiments, the at least one comfort parameter is temperature. In some embodiments, the at least one comfort parameter is room temperature. In some embodiments, the building comprises at least one room and that the at least one comfort parameter is a temperature of the at least one room of the building.

In some embodiments, the system for controlling the at least one comfort parameter is a heating and/or ventilation and/or air-conditioning system.

In some embodiments, the demand signal in in respect of a change in the at least one comfort parameter is a two-valued demand signal in in respect of a change in the at least one comfort parameter. The demand signal in in respect of a change in the at least one comfort parameter may be selected from exactly one of: temperature up, or temperature down. The demand signal in in respect of a change in the at least one comfort parameter can also be selected from exactly one of: increase temperature, or decrease temperature.

In some embodiments, the demand signal in in respect of a change in the at least one comfort parameter is selected from exactly one of: room temperature up, or room temperature down.

In some embodiments, the demand signal in in respect of a change in the at least one comfort parameter can also be selected from exactly one of: increase room temperature, or decrease room temperature.

In some embodiments, the method further comprises inputting a demand signal in respect of a change in the at least one comfort parameter, wherein the inputting is performed by a user and using the user interface device (1).

In some embodiments, the method further comprises a user employing the user interface device (1) to provide a demand signal in respect of a change in the at least one comfort parameter.

In some embodiments, the method further comprises the control device (7, 10) receiving the demand signal from the user interface device (1).

In some embodiments, the method further comprises: the user interface device (1) transmitting the demand signal to the control device (7, 10) using a digital communication bus protocol and a digital communication bus; and the control device (7, 10) receiving the demand signal from the user interface device (1) using the digital communication bus protocol and the digital communication bus.

In some embodiments, the method further comprises the control device (7, 10) connecting to the sensor (4).

In some embodiments, the method further comprises the control device (7, 10) connecting to the sensor (4) using a digital communication bus protocol and a digital communication bus.

In some embodiments, the method further comprises: the control device (7, 10) connecting to the sensor (4) using a digital, wireless communication bus; and the control device (7, 10) using the digital, wireless communication bus to obtain a reading from the sensor (4), the reading being indicative of a parameter other than the at least one comfort parameter.

In some embodiments, the method further comprises the control device (7, 10) obtaining a reading from the sensor (4), the reading being indicative of a parameter different from the at least one comfort parameter.

In some embodiments, the method further comprises: the control device (7, 10) obtaining a current state of the system for controlling the at least one comfort parameter; and the control device (7, 10) analysing the demand signal based on the current state of the system for controlling the at least one comfort parameter and based on the reading obtained from the sensor (4).

In some embodiments, the method further comprises the control device (7, 10) producing a control signal as a function of the one or more changed settings (8, 12) of the system and as a function of the reading obtained from the sensor (4).

In some embodiments, the system for controlling the at least one comfort parameter comprises a terminal unit, and the method comprises the control device (7, 10) transmitting the control signal to the terminal unit.

In some embodiments, the system for controlling the at least one comfort parameter comprises a heat exchanger, and the method further comprises the control device (7, 10) transmitting the control signal to the heat exchanger.

In some embodiments, the building comprises a smoke detector (14) and the sensor (4, 15) is a temperature sensor (15) inside the smoke detector (14), wherein the at least one comfort parameter is a room temperature of a room of the building, and the method further comprises: the control device (7, 10) obtaining a reading from the sensor (4, 15), the reading being a temperature reading indicative of a temperature inside the smoke detector (14); and the control device (7, 10) analysing the demand signal based on a current state of the system for controlling the room temperature of the room of the building and based on the temperature reading obtained from the sensor (4, 15).

In some embodiments, the system for controlling the room temperature of the room of the building comprises the smoke detector (14).

In some embodiments, the method further comprises: the control device (7, 10) obtaining a reading from the sensor (4, 15), the reading being a temperature reading indicative of a temperature inside the smoke detector (14); the control device (7, 10) obtaining a current state of the system for controlling the room temperature of the room of the building; and the control device (7, 10) analysing the demand signal based on the current state of the system for controlling the room temperature of the room of the building and based on the temperature reading obtained from the sensor (4, 15).

In some embodiments, the method further comprises the control device (7, 10) connecting to the smoke detector (14).

In some embodiments, the method further comprises the control device (7, 10) connecting to the smoke detector (14) using a digital communication bus protocol and a digital communication bus.

In some embodiments, the method further comprises the control device (7, 10) connecting to the smoke detector (14) using a digital, wireless communication bus.

In some embodiments, the method further comprises: the control device (7, 10) connecting to the smoke detector (14) using a digital communication bus protocol and a digital communication bus; and the control device (7, 10) obtaining the reading from the sensor (4, 15) via the smoke detector (14) using the digital communication bus protocol and the digital communication bus.

In some embodiments, the method further comprises: the control device (7, 10) connecting to the smoke detector (14) using a digital, wireless communication bus; and the control device (7, 10) obtaining the reading from the sensor (4, 15) via the smoke detector (14) using the digital, wireless communication bus.

In some embodiments, the method further comprises: the smoke detector (14) determining an operating condition of the smoke detector (14) selected from a fire hazard or normal operation; the smoke detector (14) upon determining that the operating condition is normal operation transmitting a reading of the temperature sensor (15) to the control device (7, 10); the control device (7, 10) receiving the reading of the temperature sensor (15), the reading being a temperature reading indicative of a temperature inside the smoke detector (14); and the control device (7, 10) analysing the demand signal based on a current state of the system for controlling the room temperature of the room of the building and based on the temperature reading.

In some embodiments, the method further comprises the smoke detector (14) determining an operating condition of the smoke detector (14) selected from exactly one of: a fire hazard or normal operation.

In some embodiments, the method further comprises: the control device (7, 10) connecting to the smoke detector (14); and once the control device (7, 10) is connected to the smoke detector (14), the smoke detector (14) determining an operating condition of the smoke detector (14) selected from: a fire hazard or normal operation.

In some embodiments, the method further comprises: the control device (7, 10) connecting to the smoke detector (14); and once the control device (7, 10) is connected to the smoke detector (14), the smoke detector (14) determining an operating condition of the smoke detector (14) selected from exactly one of: a fire hazard or normal operation.

In some embodiments, the smoke detector (14) has a microprocessor. In some embodiments, the smoke detector (14) has a microcontroller.

In some embodiments, the building comprises a computing device having a processor and wherein the sensor (4) is a temperature sensor of the processor of the computing device, wherein the at least one comfort parameter is a room temperature of a room of the building, the method further comprising: the control device (7, 10) obtaining a temperature reading from the sensor (4), the temperature reading being indicative of a temperature of the processor; and the control device (7, 10) analysing the demand signal based on a current state of the system for controlling the room temperature of the room of the building and based on the temperature reading.

In an embodiment, the system for controlling the room temperature of the room of the building comprises the computing device.

In some embodiments, the method further comprises: the control device (7, 10) obtaining a temperature reading from the sensor (4), the temperature reading being indicative of a temperature of the processor; the control device (7, 10) obtaining a current state of the system for controlling the room temperature of the room of the building; and the control device (7, 10) analysing the demand signal based on the current state of the system for controlling the room temperature of the room of the building and based on the temperature reading.

In some embodiments, the method further comprises the control device (7, 10) connecting to the computing device.

In some embodiments, the method further comprises the control device (7, 10) connecting to the computing device using a digital communication bus protocol and a digital communication bus.

In some embodiments, the method further comprises the control device (7, 10) connecting to the computing device using a digital, wireless communication bus.

In some embodiments, the method further comprises: the control device (7, 10) connecting to the computing device using a digital communication bus protocol and a digital communication bus; and the control device (7, 10) obtaining the temperature reading from the sensor (4) via the computing device using the digital communication bus protocol and the digital communication bus.

In some embodiments, the method further comprises: the control device (7, 10) connecting to the computing device using a digital, wireless communication bus; and the control device (7, 10) obtaining the temperature reading from the sensor (4) via the computing device using the digital, wireless communication bus.

In some embodiments, the method further comprises: the control device (7, 10) additionally obtaining a load reading from the processor of the computing device, the load reading being indicative of a current load of the processor; the control device (7, 10) producing an estimate of temperature based on the load reading and based on the temperature reading; and the control device (7, 10) analysing the demand signal based on a current state of the system for controlling the room temperature of the room of the building and based on the estimate of temperature.

In some embodiments, the method further comprises: the control device (7, 10) connecting to the computing device using a digital communication bus protocol and a digital communication bus; and the control device (7, 10) obtaining the load reading from the processor via the computing device using the digital communication bus protocol and the digital communication bus.

In some embodiments, the method further comprises: the control device (7, 10) connecting to the computing device using a digital, wireless communication bus; and the control device (7, 10) obtaining the load reading from the processor via the computing device using the digital, wireless communication bus.

In some embodiments, the building comprises a computing device having a processor and wherein the sensor (4) is a temperature sensor of the processor of the computing device, wherein the at least one comfort parameter is a room temperature of a room of the building, the method further comprising: the control device (7, 10) obtaining from the processor a plurality of measurement data sets, each of the measurement data sets including for a different point in time a temperature reading obtained from the sensor (4) and a load reading of and determined by the processor; the control device (7, 10) producing an estimate of temperature from the plurality of measurement data sets; and the control device (7, 10) analysing the demand signal based on a current state of the system for controlling the room temperature of the room of the building and based on the estimate of temperature.

In some embodiments, the processor is in operative communication with the control device (7, 10). In some embodiments, the computing device is in operative communication with the control device (7, 10).

In some embodiments, the building comprises a computing device having a processor and wherein the sensor (4) is a temperature sensor of the processor of the computing device, wherein the at least one comfort parameter is a room temperature of a room of the building, the method further comprising: the control device (7, 10) obtaining from the computing device a plurality of measurement data sets, each of the measurement data sets including for a different point in time a temperature reading obtained from the sensor (4) and a load reading of and determined by the processor; the control device (7, 10) producing an estimate of temperature from the plurality of measurement data sets; and the control device (7, 10) analysing the demand signal based on a current state of the system for controlling the room temperature of the room of the building and based on the estimate of temperature.

In some embodiments, the building comprises a computing device having a processor and wherein the sensor (4) is a temperature sensor of the processor of the computing device, wherein the at least one comfort parameter is a room temperature of a room of the building, the method further comprising: the control device (7, 10) obtaining from the processor a plurality of measurement data sets, each of the measurement data sets including for a different point in time a value of temperature read from the sensor (4) and a value of load of and determined by the processor; the control device (7, 10) producing an estimate of temperature from the plurality of measurement data sets; and the control device (7, 10) analysing the demand signal based on a current state of the system for controlling the room temperature of the room of the building and based on the estimate of temperature.

In some embodiments, the building comprises a computing device having a processor and wherein the sensor (4) is a temperature sensor of the processor of the computing device, wherein the at least one comfort parameter is a room temperature of a room of the building, the method further comprising: the control device (7, 10) obtaining from the computing device a plurality of measurement data sets, each of the measurement data sets including for a different point in time a value of temperature read from the sensor (4) and a value of load of and determined by the processor; the control device (7, 10) producing an estimate of temperature from the plurality of measurement data sets; and the control device (7, 10) analysing the demand signal based on a current state of the system for controlling the room temperature of the room of the building and based on the estimate of temperature.

In some embodiments, the method further comprises the control device (7, 10) performing a regression analysis to calculate the estimate of temperature from the plurality of measurement data sets.

In some embodiments, the method further comprises the control device (7, 10) performing a linear regression analysis to calculate the estimate of temperature from the plurality of measurement data sets.

In some embodiments, the building comprises a computing device having a processor and the sensor (4) is a temperature sensor of the processor of the computing device, wherein the at least one comfort parameter is a room temperature of a room of the building, the method further comprising: the processor obtaining a temperature reading from the sensor (4), the temperature reading being indicative of a temperature of the processor; the processor determining a load value, the load value being indicative of a current load of the processor; the processor producing an estimate of temperature based on the load value and based on the temperature reading; the processor transmitting the estimate of temperature to the control device (7, 10); and the control device (7, 10) analysing the demand signal based on a current state of the system for controlling the room temperature of the room of the building and based on the estimate of temperature.

In some embodiments involving a load value, the system for controlling the room temperature of the room of the building comprises the computing device. In some embodiments, the method further comprises the processor obtaining a temperature reading from the sensor (4), the temperature reading being indicative of a temperature of the processor; the processor determining a load value, the load value being indicative of a current load of the processor;

the processor producing an estimate of temperature based on the load value and based on the temperature reading; the processor transmitting the estimate of temperature to the control device (7, 10); the control device (7, 10) obtaining a current state of the system for controlling the room temperature of the room of the building; and the control device (7, 10) analysing the demand signal based on the current state of the system for controlling the room temperature of the room of the building and based on the estimate of temperature.

In some embodiments, the method further comprises the computing device connecting to the control device (7, 10).

In some embodiments, the method further comprises the computing device connecting to the control device (7, 10) using a digital communication bus protocol and a digital communication bus.

In some embodiments, the method further comprises the computing device connecting to the control device (7, 10) using a digital, wireless communication bus.

In some embodiments, the method further comprises: the computing device connecting to the control device (7, 10) using a digital communication bus protocol and a digital communication bus; and the processor transmitting the estimate of temperature to the control device (7, 10) via the computing device and using the digital communication bus protocol and the digital communication bus.

In some embodiments, the method further comprises: the computing device connecting to the control device (7, 10) using a digital, wireless communication bus; and the processor transmitting the estimate of temperature to the control device (7, 10) via the computing device and using the digital, wireless communication bus.

In some embodiments, the building comprises a computing device having a processor and wherein the sensor (4) is a temperature sensor of the processor of the computing device, wherein the at least one comfort parameter is a room temperature of a room of the building, and the method further comprises: the processor collecting a plurality of measurement data sets, each of the measurement data sets including for a different point in time a temperature reading obtained from the sensor (4) and a load reading of and determined by the processor; the processor producing an estimate of temperature from the plurality of measurement data sets; the processor transmitting the estimate of temperature to the control device (7, 10); and the control device (7, 10) analysing the demand signal based on a current state of the system for controlling the room temperature of the room of the building and based on the estimate of temperature.

In some embodiments, the processor is in operative communication with the control device (7, 10). In some embodiments, the computing device is in operative communication with the control device (7, 10).

In some embodiments, the building comprises a computing device having a processor and wherein the sensor (4) is a temperature sensor of the processor of the computing device, wherein the at least one comfort parameter is a room temperature of a room of the building, the method further comprising: the processor collecting a plurality of measurement data sets, each of the measurement data sets including for a different point in time a value of temperature read from the sensor (4) and a value of load of and determined by the processor; the processor producing an estimate of temperature from the plurality of measurement data sets; the processor transmitting the estimate of temperature to the control device (7, 10); and the control device (7, 10) analysing the demand signal based on a current state of the system for controlling the room temperature of the room of the building and based on the estimate of temperature.

In some embodiments, the method further comprises the processor performing a regression analysis to calculate the estimate of temperature from the plurality of measurement data sets.

In some embodiments, the method further comprises the processor performing a linear regression analysis to calculate the estimate of temperature from the plurality of measurement data sets.

In some embodiments, the building comprises a sensor assembly (32, 33) having an auxiliary temperature sensor for compensating temperature drift of the sensor assembly (32, 33), a room (27), and a duct (29, 31) selected from an inlet duct for flow of air from outside the building to the room (27) or an outlet duct for flow of air from the room (27) out of the building, wherein the sensor assembly (32, 33) is secured relative to the duct (29, 31), wherein the at least one comfort parameter is a room temperature of the room (27) of the building, wherein the sensor (4) is the auxiliary temperature sensor of the sensor assembly (32, 33), the method comprising the steps of: the control device (7, 10) obtaining a reading from the sensor (4), the reading being a temperature reading indicative of a temperature inside the duct (29, 31); and the control device (7, 10) analysing the demand signal based on a current state of the system for controlling the room temperature of the room (27) of the building and based on the temperature reading obtained from the sensor (4).

In some embodiments, the sensor assembly (32, 33) comprises a pressure sensor. In some embodiments, the sensor assembly (32, 33) is a pressure sensor.

In some embodiments, the sensor assembly (32, 33) is arranged in the duct (29, 31).

In some embodiments, the system for controlling the room temperature of the room (27) of the building comprises the sensor assembly (32, 33).

In some embodiments, the method further comprises: the control device (7, 10) obtaining a reading from the sensor (4), the reading being a temperature reading indicative of a temperature inside the duct (29, 31); the control device (7, 10) obtaining a current state of the system for controlling the room temperature of the room (27) of the building; and the control device (7, 10) analysing the demand signal based on the current state of the system for controlling the room temperature of the room (27) of the building and based on the temperature reading obtained from the sensor (4).

In some embodiments, the method further comprises the control device (7, 10) connecting to the sensor assembly (32, 33).

In some embodiments, the method further comprises the control device (7, 10) connecting to the sensor assembly (32, 33) using a digital communication bus protocol and a digital communication bus.

In some embodiments, the method further comprises the control device (7, 10) connecting to the sensor assembly (32, 33) using a digital, wireless communication bus.

In some embodiments, the method further comprises: the control device (7, 10) connecting to the sensor assembly (32, 33) using a digital communication bus protocol and a digital communication bus; and the control device (7, 10) obtaining the reading from the sensor (4) via the sensor assembly (32, 33) using the digital communication bus protocol and the digital communication bus.

In some embodiments, the method further comprises: the control device (7, 10) connecting to the sensor assembly (32, 33) using the digital, wireless communication bus; and the control device (7, 10) obtaining the reading from the sensor (4) via the sensor assembly (32, 33) using the digital, wireless communication bus.

In some embodiments, the building comprises a first sensor assembly (32) having a first auxiliary temperature sensor for compensating temperature drift of the first sensor assembly (32) and a second sensor assembly (33) having a second auxiliary temperature sensor for compensating temperature drift of the second sensor assembly (33), a room (27), and an inlet duct (29) for flow of air from outside the building to the room (27) and an outlet duct (31) for flow of air from the room (27) out of the building, wherein the first sensor assembly (32) is secured relative to the inlet duct (29) and the second sensor assembly (33) is secured relative to the outlet duct (31), wherein the at least one comfort parameter is a room temperature of the room (27) of the building, the method comprising the steps of: the control device (7, 10) obtaining a first reading from the first auxiliary temperature sensor of the first sensor assembly (32), the first reading being a temperature reading indicative of a temperature inside the inlet duct (29); the control device (7, 10) obtaining a second reading from the second auxiliary temperature sensor of the second sensor assembly (33), the second reading being a temperature reading indicative of a temperature inside the outlet duct (31); and the control device (7, 10) analysing the demand signal based on a current state of the system for controlling the room temperature of the room (27) of the building and based on the first reading and based on the second reading.

In some embodiments, the first sensor assembly (32) comprises a first pressure sensor. In some embodiments, the first sensor assembly (32) is a first pressure sensor. In some embodiments, the second sensor assembly (33) comprises a second pressure sensor. In some embodiments, the second sensor assembly (33) is a second pressure sensor. In some embodiments, the first sensor assembly (32) is arranged in the inlet duct (29). In some embodiments, the second sensor assembly (33) is arranged in the outlet duct (31).

In some embodiments, the method further comprises: the control device (7, 10) obtaining a first reading from the first auxiliary temperature sensor of the first sensor assembly (32), the first reading being a temperature reading indicative of a temperature inside the inlet duct (29); the control device (7, 10) obtaining a second reading from the second auxiliary temperature sensor of the second sensor assembly (33), the second reading being a temperature reading indicative of a temperature inside the outlet duct (31); the control device (7, 10) obtaining a current state of the system for controlling the room temperature of the room (27) of the building; and the control device (7, 10) analysing the demand signal based on the current state of the system for controlling the room temperature of the room (27) of the building and based on the first reading and based on the second reading.

In some embodiments, the method further comprises the control device (7, 10) connecting to the first sensor assembly (32) and to the second sensor assembly (33).

In some embodiments, the method further comprises the control device (7, 10) connecting to the first sensor assembly (32) and to the second sensor assembly (33) using a digital communication bus protocol and a digital communication bus.

In some embodiments, the method further comprises the control device (7, 10) connecting to the first sensor assembly (32) and to the second sensor assembly (33) using a digital, wireless communication bus.

In some embodiments, the method further comprises: the control device (7, 10) connecting to the first sensor assembly (32) and to the second sensor assembly (33) using a digital communication bus protocol and a digital communication bus; and the control device (7, 10) obtaining the first reading from the first auxiliary temperature sensor via the first sensor assembly (32) using the digital communication bus protocol and the digital communication bus and obtaining the second reading from the second auxiliary temperature sensor via the second sensor assembly (33) using the digital communication bus protocol and the digital communication bus.

In some embodiments, the method further comprises: the control device (7, 10) connecting to the first sensor assembly (32) and to the second sensor assembly (33) using the digital, wireless communication bus; and the control device (7, 10) obtaining the first reading via the first sensor assembly (32) using the digital, wireless communication bus and obtaining the second reading via the second sensor assembly (33) using the digital, wireless communication bus.

In some embodiments, the method further comprises: the control device (7, 10) producing a first measure of temperature from the first reading; the control device (7, 10) producing a second measure of temperature from the second reading; the control device (7, 10) producing an estimate of temperature by averaging the first and second measures of temperature; and the control device (7, 10) analysing the demand signal based on a current state of the system for controlling the room temperature of the room (27) of the building and based on the estimate of temperature.

In some embodiments, the control device (7, 10) produces an estimate of temperature p by arithmetically averaging the first T₁ and second T₂ measures of temperature:

$$μ = \frac{1}{2} ( {T}_{1} + {T}_{2} )$$

In some embodiments, the control device (7, 10) produces an estimate of temperature p by geometrically averaging the first T₁ and second T₂ measures of temperature:

μ=\sqrt{T₁·T₂}

In some embodiments, the method further comprises: the control device (7, 10) producing a first measure of temperature from the first reading; the control device (7, 10) producing a second measure of temperature from the second reading; the control device (7, 10) producing an estimate of temperature by averaging the first and second measures of temperature; the control device (7, 10) obtaining a current state of the system for controlling the room temperature of the room (27) of the building; and the control device (7, 10) analysing the demand signal based on the current state of the system for controlling the room temperature of the room (27) of the building and based on the estimate of temperature.

As described in detail herein, the present disclosure further teaches a computer program comprising instructions which, when the program is executed by a computer, cause the computer to carry out the steps of any of the methods of the instant disclosure.

The instant disclosure also teaches a computer program comprising instructions which, when the program is executed by one or more processors of a system for controlling at least one comfort parameter, cause the one or more processors to carry out the steps of any of the methods of the instant disclosure.

As described in detail herein, the present disclosure further teaches a computer-readable medium comprising instructions which, when executed by a computer, cause the computer to carry out the steps of any of the methods described herein.

The instant disclosure also teaches a computer-readable medium comprising instructions which, when executed by one or more processors of a system for controlling at least one comfort parameter, cause the one or more processors to carry out the steps of any of the methods of the instant disclosure.

It should be understood that the foregoing relates only to certain embodiments of the disclosure and that numerous changes can be made therein without departing from the scope of the disclosure as defined by the following claims. It should also be understood that the disclosure is not restricted to the illustrated embodiments and that various modifications can be made within the scope of the claims.

### REFERENCE NUMERALS

1 user interface device
2 input device
3 room
4 sensor
5 one or more actuators
6 output device
7 heating/cooling module
8 basic settings
9 operations module
10 control/regulation module
11 clock
12 temporary change
13 override switch
14 smoke detector
15 temperature sensor of the smoke detector
16 temperature
17 load
18 sensor
19 diaphragm
20 electrode
21 electrode
22 meandering pattern
23 terminal
24 terminal
25 segment
26 segment
27 space
28 fan
29 inlet duct
30 fan
31 outlet duct
32 sensor assembly
33 sensor assembly

1. A method of controlling a comfort parameter in a building with a system for controlling the comfort parameter, the system comprising a user interface device, a sensor, and a control device, wherein the sensor measures a parameter different from the comfort parameter, the method comprising:
providing a demand signal requesting a change in the comfort parameter from a user using the user interface device;
transmitting the demand signal from the user interface device to the control device;
obtaining a reading from the sensor, the reading corresponding to a value of the parameter;
analyzing the demand signal based on a current state of the system the reading obtained from the sensor;
changing one or more settings of the system based on the analysis of the demand signal; and
producing a control signal as a function of the one or more changed settings of the system.

2. The method according to claim 1, wherein:
the sensor comprises a temperature sensor inside a smoke detector, wherein the comfort parameter is a temperature of a room in the building; and
the method further comprises:
obtaining a reading from the sensor, the reading representing a temperature inside the smoke detector; and
analysing the demand signal based on a current state of the system the temperature reading obtained from the sensor.

3. The method according to claim 2, the method further comprising:
determining an operating condition of the smoke detector as either a fire hazard or normal operation;
upon determining that the operating condition is normal operation, transmitting a reading of the temperature sensor to the control device;
receiving the reading of the temperature sensor, the reading being indicative of a temperature inside the smoke detector; and
analysing the demand signal based on a current state of the system and the temperature reading.

4. The method according to claim 1, wherein:
the building comprises a computing device having a processor; and
the sensor comprises a temperature sensor of the processor of the computing device;
the comfort parameter is a room temperature of a room of the building; and
the method further comprises:
obtaining a temperature reading from the sensor, the temperature reading indicating a temperature of the processor; and
analysing the demand signal based on a current state of the system and the temperature reading.

5. The method according to claim 4, further comprising:
additionally obtaining a load reading from the processor of the computing device, the load reading indicating a current load of the processor;
producing an estimate of temperature based on the load reading and the temperature reading; and
analysing the demand signal based on a current state of the system and the estimate of temperature.

6. The method according to claim 1, wherein:
the building comprises a computing device having a processor and
the sensor comprises a temperature sensor of the processor of the computing device;
the comfort parameter is a room temperature of a room of the building; and
the method further comprises:
obtaining from the processor a plurality of measurement data sets, each of the measurement data sets including for a different point in time a temperature reading obtained from the sensor and a load reading of and determined by the processor;
producing an estimate of temperature from the plurality of measurement data sets; and
analysing the demand signal based on a current state of the system and the estimate of temperature.

7. The method according to claim 6, the method further comprising performing a regression analysis to calculate the estimate of temperature from the plurality of measurement data sets.

8. The method according to claim 1, wherein:
the building comprises a computing device having a processor;
the sensor comprises a temperature sensor of the processor of the computing device;
the comfort parameter is a room temperature of a room of the building; and
the method further comprises:
obtaining a temperature reading from the sensor, the temperature reading indicative of a temperature of the processor;
determining a load value indicative of a current load of the processor;
producing an estimate of temperature based on the load value and the temperature reading;
transmitting the estimate of temperature to the control device; and
analysing the demand signal based on a current state of the system and the estimate of temperature.

9. The method according to claim 1, wherein:
the building comprises a computing device having a processor;
the sensor comprises a temperature sensor of the processor of the computing device;
the comfort parameter is a room temperature of a room of the building; and
the method further comprises:
collecting a plurality of measurement data sets, each of the measurement data sets including for a different point in time a temperature reading obtained from the sensor and a load reading of the processor;
producing an estimate of temperature from the plurality of measurement data sets;
transmitting the estimate of temperature to the control device; and
analysing the demand signal based on a current state of the system and the estimate of temperature.

10. The method according to claim 9, the method further comprising performing a regression analysis to calculate the estimate of temperature from the plurality of measurement data sets.

11. The method according to claim 1, wherein:
the building comprises a sensor assembly having an auxiliary temperature sensor for compensating temperature drift of the sensor assembly, a room, and at least one of an inlet duct for flow of air from outside the building to the room or an outlet duct for flow of air from the room out of the building;
the sensor assembly is secured relative to the duct;
the comfort parameter is a room temperature of the room;
the sensor comprises the auxiliary temperature sensor of the sensor assembly; and
the method further comprises:
obtaining a reading from the sensor, the reading indicative of a temperature inside the duct; and
analysing the demand signal based on a current state of the system and the temperature reading obtained from the sensor.

12. The method according to claim 1, wherein:
the building comprises a first sensor assembly having a first auxiliary temperature sensor for compensating temperature drift of the first sensor assembly and a second sensor assembly having a second auxiliary temperature sensor for compensating temperature drift of the second sensor assembly, a room, an inlet duct for flow of air from outside the building to the room, and an outlet duct for flow of air from the room out of the building;
the first sensor assembly is secured relative to the inlet duct;
the second sensor assembly is secured relative to the outlet duct;
the comfort parameter is a room temperature of the room; and
the method further comprises:
obtaining a first reading from the first auxiliary temperature sensor of the first sensor assembly, the first reading indicative of a temperature inside the inlet duct;
obtaining a second reading from the second auxiliary temperature sensor of the second sensor assembly, the second reading indicative of a temperature inside the outlet duct; and
analysing the demand signal based on a current state of the system, the first reading, and the second reading.

13. The method according to claim 12, the method further comprising:
producing a first measure of temperature from the first reading;
producing a second measure of temperature from the second reading;
producing an estimate of temperature by averaging the first and second measures of temperature; and
analysing the demand signal based on a current state of the system for controlling the room temperature of the room of the building and the estimate of temperature.

14. A computer-readable medium comprising instructions which, when executed by a computer, cause the computer to carry out a method comprising:
providing a demand signal requesting a change in the comfort parameter from a user using the user interface device;
transmitting the demand signal from the user interface device to the control device;
obtaining a reading from the sensor, the reading corresponding to a value of the parameter;
analyzing the demand signal based on a current state of the system the reading obtained from the sensor;
changing one or more settings of the system based on the analysis of the demand signal; and
producing a control signal as a function of the one or more changed settings of the system.
